(19) United States
(12) Patent Application Publication
(10) Pub. No.: US 2026/0212686 A1
(43) Pub. Date: Jul. 23, 2026

(54) VEHICLE SYSTEMS AND METHODS FOR ENHANCING DISPLAY OF PARKING SPACE LINES

(71) Applicant: GM GLOBAL TECHNOLOGY OPERATIONS LLC, Detroit, MI (US)

(72) Inventors: Mohammad NASERIAN, Windsor (CA); Kamran Ali, Troy, MI (US); Esther Anderson, Canton, MI (US)

(21) Appl. No.: 19/034,759

(22) Filed: Jan. 23, 2025

(51) Int. Cl. G06V 20/58; B60R 1/23; G06T 11/00; G06T 11/20

(52) U.S. Cl. CPC G06V 20/586; B60R 1/23; G06T 11/10; G06T 11/23; B60R 2300/308

(57) ABSTRACT

A vehicle system includes one or more cameras configured to capture one or more images external to a vehicle, a control module, and a display module. The control module is configured to detect a portion of a parking space line defining at least a portion of a parking space based on the one or more captured images, generate an estimated polynomial representing the parking space line based on the detected portion of the parking space line, and generate a virtual parking space line corresponding to at least one missing portion of the parking space line based on the estimated polynomial. The display module is configured to render a view with the virtual parking space line superimposed over the parking space line. Other example vehicle systems and methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle systems and methods for enhancing display of parking space lines.

Vehicles include onboard cameras to provide information about the surrounding environment that can be used for rendering views for display and/or for various operations of the vehicles. For instance, a vehicle may rely on images captured by the cameras for rendering a bird's eye view of the vehicle, a front view of the vehicle, a rear view of the vehicle, side views of the vehicle, etc. Sometimes, the rendered views may provide lines representing an expected trajectory of the vehicle, a front end of the vehicle, a backend of the vehicle, etc. relative to, for example, external objects (e.g., a parking space line, a curb, a wall, etc.).

### SUMMARY

A vehicle system for enhancing display of at least one parking space line adjacent to a vehicle, includes one or more cameras configured to capture one or more images external to the vehicle, a control module in communication with the one or more cameras, and a display module in communication with the control module. The control module is configured to detect a portion of a parking space line defining at least a portion of a parking space based on the one or more captured images, generate an estimated polynomial representing the parking space line based on the detected portion of the parking space line, and generate a virtual parking space line corresponding to at least one missing portion of the parking space line based on the estimated polynomial. The display module is configured to render a view with the virtual parking space line superimposed over the parking space line.

In other features, the parking space line is a line extending substantially parallel to the vehicle when the vehicle is located in the parking space.

In other features, the control module is configured to generate the virtual parking space line extending to a horizon line associated with the parking space.

In other features, the estimated polynomial is a first estimated polynomial, and the control module is configured to detect a feature of a vehicle adjacent to the parking space, generate a second estimated polynomial representing the feature of the adjacent vehicle, and generate the virtual parking space line based on the first estimated polynomial and the second estimated polynomial.

In other features, the control module is configured to apply a weight to each of the first estimated polynomial and the second estimated polynomial, and generate the virtual parking space line based on the weighted first estimated polynomial, and the weighted second estimated polynomial.

In other features, the estimated polynomial is a first estimated polynomial, and the control module is configured to receive map data for an area adjacent to or encompassing the parking space, generate a second estimated polynomial representing the parking space line based on the map data, and generate the virtual parking space line based on the first estimated polynomial and the second estimated polynomial.

In other features, the control module is configured to apply a weight to each of the first estimated polynomial and the second estimated polynomial and generate the virtual parking space line based on the weighted first estimated polynomial and the weighted second estimated polynomial.

In other features, the control module is configured to receive data representing the one or more captured images in a first coordinate system, apply a transform to the data to convert the data into a second coordinate system, and detect the portion of the parking space line and generate the estimated polynomial based on the transformed data.

In other features, the control module is configured to detect a plurality of lines of including the portion of the parking space line and apply a filter to the plurality of lines based on a defined set of colors to identify the portion of the parking space line.

In other features, the control module is configured to detect a plurality of colors associated with the portion of the parking space line, select one of the detected colors based on a number of occurrences of each detected color, and generate the virtual parking space line with the selected color.

In other features, the control module is configured to detect a color associated with the portion of the parking space line and generate the virtual parking space line with the detected color.

A vehicle system for enhancing display of at least one parking space line adjacent to a vehicle, includes one or more cameras configured to capture one or more images external to the vehicle, a control module in communication with the one or more cameras, and a display module in communication with the control module. The control module is configured to detect a portion of a parking space line defining at least a portion of a parking space based on the one or more captured images and generate a first estimated polynomial representing the parking space line based on the detected portion of the parking space line, detect a feature of a vehicle adjacent to the parking space based on the one or more captured images and generate a second estimated polynomial representing the feature of the adjacent vehicle, receive map data for an area adjacent to or encompassing the parking space and generate a third estimated polynomial representing the parking space line based on the map data, and generate a virtual parking space line corresponding to at least one missing portion of the parking space line based on the first estimated polynomial, the second estimated polynomial, and the estimated polynomial. The display module is configured to render a view with the virtual parking space line superimposed over the parking space line.

In other features, the control module is configured to apply a weight to each of the first estimated polynomial, the second estimated polynomial, and the third estimated polynomial, and generate the virtual parking space line based on the weighted first estimated polynomial, the weighted second estimated polynomial, and the weighted third estimated polynomial.

In other features, the control module is configured to detect a color associated with the portion of the parking space line and generate the virtual parking space line with the detected color.

A method for enhancing display of at least one parking space line adjacent to a vehicle, includes capturing one or more images external to the vehicle, detecting a portion of a parking space line defining at least a portion of a parking space based on the one or more captured images, generating an estimated polynomial representing the parking space line based on the detected portion of the parking space line, generating a virtual parking space line corresponding to at least one missing portion of the parking space line based on the estimated polynomial, and rendering, on a display module, a view with the virtual parking space line superimposed over the parking space line.

In other features, the parking space line is a line extending substantially parallel to the vehicle when the vehicle is located in the parking space, and generating the virtual parking space line includes generating the virtual parking space line extending to a horizon line associated with the parking space.

In other features, the estimated polynomial is a first estimated polynomial, the method further includes detecting a feature of a vehicle adjacent to the parking space, and generating a second estimated polynomial representing the feature of the adjacent vehicle, and generating the virtual parking space line includes generating the virtual parking space line based on the first estimated polynomial and the second estimated polynomial.

In other features, the method further includes receiving map data for an area adjacent to or encompassing the parking space and generating a third estimated polynomial representing the parking space line based on the map data, and generating the virtual parking space line includes generating the virtual parking space line based on the first estimated polynomial, the second estimated polynomial, and the third estimated polynomial.

In other features, the method further includes applying a weight to each of the first estimated polynomial, the second estimated polynomial, and the third estimated polynomial, and generating the virtual parking space line includes generating the virtual parking space line based on the weighted first estimated polynomial, the weighted second estimated polynomial, and the weighted third estimated polynomial.

In other features, the method further includes detecting a plurality of colors associated with the portion of the parking space line and selecting one of the detected colors based on a number of occurrences of each detected color, and generating the virtual parking space line includes generating the virtual parking space line with the selected color.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of a vehicle system for enhancing display of a parking space line, according to the present disclosure;

FIG. 2 is an example image showing parking spaces and parking space lines, according to the present disclosure;

FIG. 3 is an example of virtual parking space lines for the parking space lines of FIG. 2, according to the present disclosure;

FIG. 4 is another example image showing parking spaces and detected parking space lines and vehicle features, according to the present disclosure;

FIGS. 5-6 are example images with map information received by the vehicle system of FIG. 1, according to the present disclosure;

FIGS. 7-8 are example displays of views with virtual parking space lines, according to the present disclosure; and

FIGS. 9-10 are flowcharts of example processes for enhancing display of a parking space line, according to the present disclosure.

In the drawings, reference numbers may be reused to identify similar and/or identical elements.

### DETAILED DESCRIPTION

Vehicles include onboard cameras to provide information about the surrounding environment that can be used for rendering views for display. For instance, a vehicle may rely on images captured by the cameras for rendering a bird's eye view of the vehicle, a front view of the vehicle, a rear view of the vehicle, side views of the vehicle, etc. In such examples, the captured images may include various objects external to the vehicle, such as parking space lines, other vehicles, curbs, etc. Such objects are then provided with the displayed views. Some objects, such as parking space lines are rarely in perfect condition. For example, parking space lines are often worn away (e.g., degraded over time) and/or are obscured (e.g., by dirt, snow, etc.). In other instances, parking space lines are difficult to see in the views due to, for example, a glare from the sun or another light source on the driving surface and/or the display. Additionally, low lighting, shadows, etc. may lead to difficulties of viewing parking space lines. Due to such lack of visibility in the displayed views, the vehicle driver may experience difficulties parking the vehicle in a desired space.

The vehicle systems and methods according to the present disclosure leverage image processing techniques to identify remnants of parking space lines and superimpose virtual lines to aid drivers. For example, and as further explained herein, the vehicle systems and methods detect parking space lines in images captured by vehicle camera(s) and if disturbances in the parking space lines exist, generate virtual parking space lines for at least the disturbances based on estimated polynomials representative of the detected parking space lines. In various embodiments, the vehicle systems and methods may also rely on one or more other optional estimated polynomials representative of other detected lines from the same vehicle camera(s) and/or other sources, to generate the virtual parking space lines. Then, the vehicle systems and methods superimpose the virtual parking space lines on the view for display. In doing so, a driver is provided full and distinct parking space lines and in turn a more accurate and comprehensive representation of a parking space, even under challenging conditions. This significantly improves the driver's ability to align and maneuver the vehicle correctly and enhances overall parking safety.

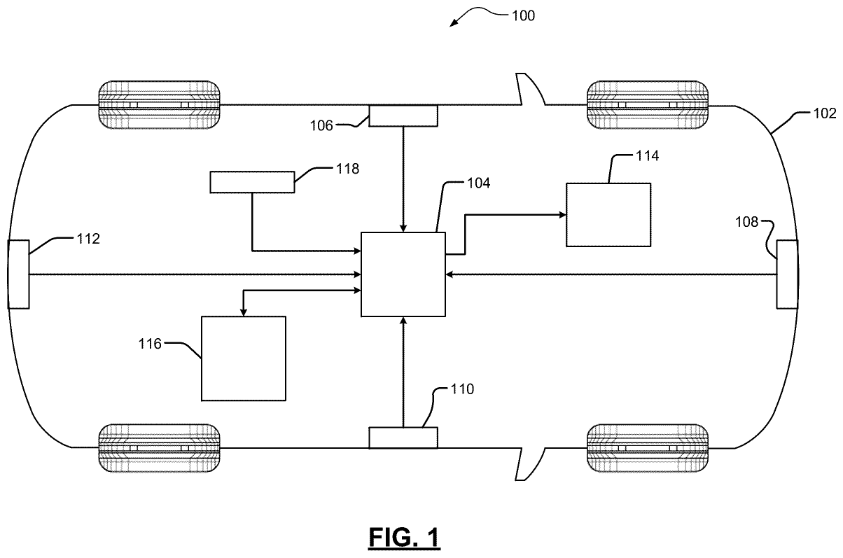

Referring now to FIG. 1, a block diagram of an example vehicle system 100 is presented for enhancing display of a parking space line adjacent to a vehicle 102. As shown in FIG. 1, the vehicle system 100 generally includes a control module 104, cameras 106, 108, 110, 112, a display module 114, a memory circuit 116, and one or more sensors 118. In the example of FIG. 1, the memory circuit 116 may be external to the control module 104 as shown or internal to the control module 104 if desired. Although FIG. 1 illustrates the vehicle system 100 as including specific dedicated modules, it should be appreciated that one or more other modules may be employed if desired. For example, any combination of the modules (e.g., the control module 104 and the display module 114) and/or the functionality thereof may be integrated into a single module or multiple different modules.

The vehicle system 100 of FIG. 1 may be employable in any suitable vehicle, such as an autonomous vehicle, a semi-autonomous vehicle, etc. Additionally, the vehicle system 100 may be applicable to electric vehicles (e.g., a pure electric vehicle, a plug-in hybrid electric vehicle, etc.) and internal combustion engine (ICE) vehicles. In the example of FIG. 1, the vehicle system 100 is employed in the vehicle 102, which may be an autonomous vehicle, a semi-autonomous, etc.

The cameras 106, 108, 110, 112, the display module 114, the memory circuit 116, and the sensor(s) 118 are in communication with the control module 104. In such examples, the control module 104 may receive and/or transmit signals, data, etc. from and/or to each of the cameras 106, 108, 110, 112, the display module 114, the memory circuit 116, and the sensor(s) 118. In such examples, the control module 104 may receive and/or transmit signals, data, etc. via a network, such as a controller area network (CAN).

In the example of FIG. 1, the cameras 106, 108, 110, 112 are positioned to capture one or more images external to the vehicle 102. In various embodiments, the camera 108 may be a front-end camera module, the camera 112 may be a rear-end camera module, and the cameras 106, 110 may be side camera modules. Although the vehicle system 100 of FIG. 1 is shown as including four cameras positioned at specific locations relative to the vehicle 102, it should be appreciated that in other embodiment, the vehicle system 100 may include more or less cameras, cameras at different locations, etc.

In various embodiments, the vehicle system 100 generates a virtual parking space line for assisting a driver in parking maneuvers. For example, the vehicle system 100 generally utilizes a line detection and reconstruction algorithm to detect a parking space line based on captured image(s) from one or more of the cameras 106, 108, 110, 112. Then, the vehicle system 100 generates a virtual parking space line corresponding to missing portion(s) of the parking space line. Based on the analysis performed by the line detection and reconstruction algorithm, the vehicle system 100 utilizes the display module 114 (e.g., a real-time rendering module, etc.) to overlay the virtual line on the missing portion(s) of the parking space line on the actual displayed images for the driver. In such examples, the rendering is seamlessly integrated with a live video feed, providing an augmented display of the parking space line. Additionally, the vehicle system 100 may include a user-friendly interface that allows the driver to configure display settings, such as a line thickness, color, transparency, etc. of the virtual line. Further, in various embodiments, the interface may provide options to enable or disable the augmented display feature, depending on the driver's preferences.

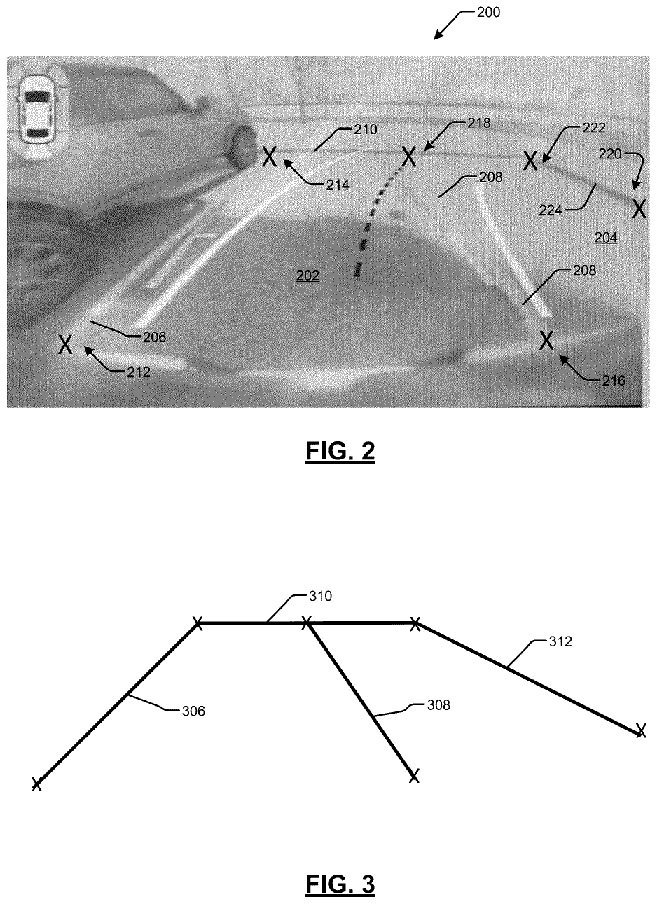

FIG. 2 depicts one example of a captured image 200 that may be utilized by the line detection and reconstruction algorithm of the vehicle system 100 of FIG. 1. For example, in FIG. 2, the image 200 includes parking spaces 202, 204 defined by parking space lines 206, 208 and curbs 210, 224. Specifically, the parking space 202 is defined by the parking space lines 206, 208 and the curb 210, and the parking space 204 is defined by the parking space line 208 and the curbs 210, 224. In this example, the parking space line 206, 208 and the curbs 210, 224 are difficult to view due to, for example, degradation, obscurations, glare, etc.

The vehicle system 100 may detect the parking space lines 206, 208 and the curbs 210, 224 as further explained herein, and then generate virtual parking space lines corresponding to missing portion(s) of or the entire parking space lines 206, 208 and the curbs 210, 224. In such examples, the vehicle system 100 may rely on existing markers (e.g., curbs, endpoints of lines, etc.) to extrapolate equations to represent the parking space lines 206, 208 and the curbs 210, 224. As examples only, markers 212, 214, 216, 218, 220, 222 are shown in FIG. 2 as X's. In this example, the markers 212, 216 are general endpoints of the parking space lines 206, 208, the markers 214, 218 are points along the curb 210 corresponding with the parking space lines 206, 208, and the markers 220, 222 are points along the curb 224.

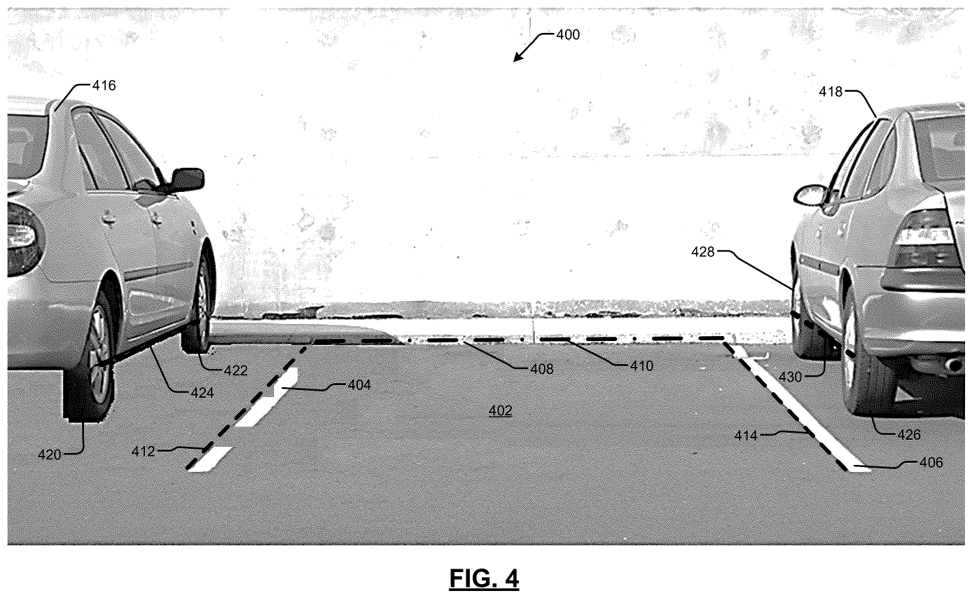

Because the parking space lines 206, 208 and the curbs 210, 224 are generally straight lines, the vehicle system 100 may use interpolation between existing markers and then extrapolate equations of the parking space lines 206, 208 and the curbs 210, 224 that extend beyond the existing markers, as further explained below. For example, FIG. 3 depicts one example of virtual lines 306, 308, 310, 312 corresponding to the parking space lines 206, 208 and the curbs 210, 224 of FIG. 2.

In various embodiments, the control module 104 of FIG. 1 may implement the line detection and reconstruction algorithm for line detection. For example, after receiving the captured image(s), the control module 104 may detect at least a portion of a parking space line (e.g., the parking space line 206 of FIG. 2) based on one or more of the captured image(s). In such examples, the parking space line may be a line extending substantially parallel to the vehicle 102 when the vehicle is located in the parking space.

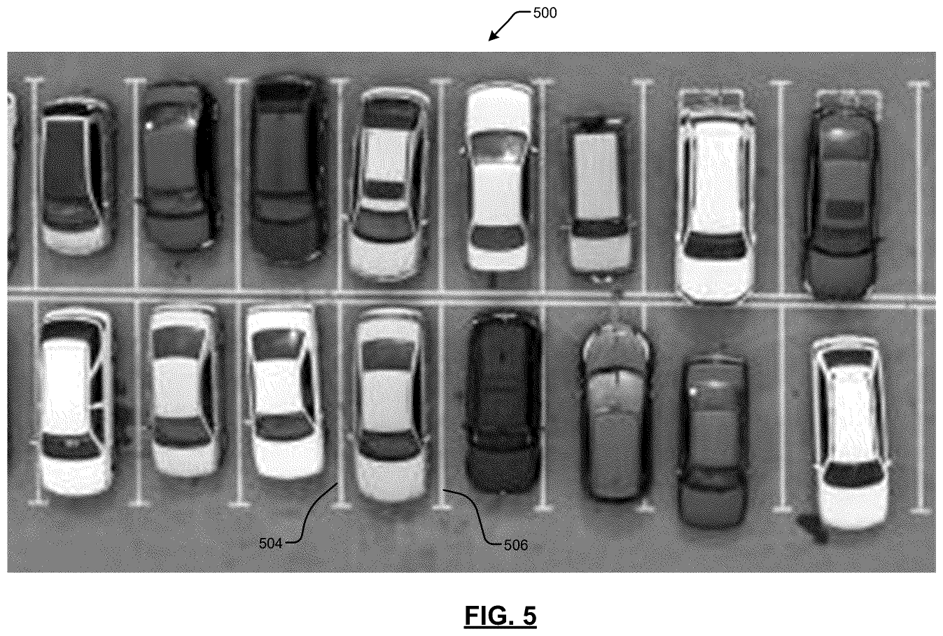

For example, FIG. 4 depicts one example of an image 400 including a parking space 402 defined by parking space lines 404, 406 and a parking stone 408. In this example, the parking space lines 404, 406 are vertical lines that generally extend parallel to the vehicle 102 when located in the parking space 402. Additionally, in this example, the parking stone 408 functions as a horizon line associated with the parking space 402 that generally separates the ground (e.g., the parking space 402) and an area above the ground. As shown, the parking stone 408 (or sometimes a curb) is detected by the control module 104 from the capture image and is represented by a line 410 (having a dashed-dashed-dot configuration) extending in a different direction (e.g., traverse, orthogonal, etc.) as the parking space lines 404, 406.

In various embodiments, the control module 104 may detect the parking space lines 404, 406 or at least a portion thereof. In such examples, the control module 104 may implement an edge detection algorithm to detect the lines 404, 406. For instance, the control module 104 may initially perform image distortion correction of the received image(s) from one or more of the cameras 106, 108, 110, 112, and then initiate an edge detection technique to detect edges of objects in the capture image(s). In some examples, the control module 104 may implement a Canny edge detector approach or another suitable approach to detect edges of objects in the image(s). For example, in the Canny edge detector approach, as the sigma value (e.g., the degree of image smoothing) is increased, the resolution of the edge detection is decreased. In some examples, parking line detection works best with high sigma values to filter out high resolution lines like cracks in the asphalt.

Then, the control module 104 may filter edges to focus on vertical edges. For example, and with respect to FIG. 4, the control module 104 may filter out detected edges associated with the parking stone 408 and maintain detected edges associated with the parking space lines 404, 406. For instance, the parking stone 408 (or curb) extends perpendicular and not vertical. In this example, the parking space lines 404, 406 diverge from the parking stone 408 (e.g., the horizon line) as they approach the vehicle 102 and are typically generally 8.5-9 feet apart. Such standard norms assist the edge detection algorithm to separate signal from noise.

In the example of FIG. 4, the control module 104 detects edges 412, 414 of the parking space lines 404, 406, respectively. The edges 412, 414 are represented by lines having a dashed configuration. While FIG. 4 shows left side edges of the of the parking space lines 404, 406 being detected, it should be appreciated that right edges may be also or alternatively detected as well.

Next, the control module 104 may apply a transform to detect line targets in the captured image(s). For example, the control module 104 may implement a Hough Transform or another suitable transform for such purposes. In examples where a Hough Transform is used, each point (e.g., xᵢ, yᵢ) on a detected edge coming out of the filter is converted from an image space to become a line (c, m) in parameter space. As multiple lines are drawn in parameter space, an intersection will develop. This intersection point can now be converted back into the image space and becomes a line, and in this case a detected line.

In various embodiments, the control module 104 may apply may implement line detection if one or more conditions apply. For example, the control module 104 may initiate line detection only if the vehicle 102 is located in a parking lot. In such examples, the control module 104 may receive GPS data or the like from one of the sensors 118 and known parking lot locations stored in the memory 116 (or in a location external to the vehicle 102) and determine whether the vehicle 102 is located in a parking lot based on this information. Additionally, the control module 104 may initiate line detection only if the vehicle speed is less than or equal to a defined threshold (e.g., a calibrated value), such as 4 km/hr, 5 km/hr, 6 km/hr, etc. The control module 104 may make this determination based on vehicle speed data provided one of the sensors 118.

Then, in various embodiments, the control module 104 may generate an estimated polynomial representing each parking space line 404, 406 or the edges 412, 414 thereof. In such examples, the estimated polynomial is generated based on the detected portion of the respective parking space line 404, 406. For instance, a line may be represented by a polynomial equation with a certain curvature (if appropriate). In such examples, a radius of curvature of each line may be computed when equations of the curve are known. As example only, Equation (1) below is a polynomial equation, and Equation (2) is a radius of curvature equation that may be employed.

$$f ( y ) = {Ay}^{2} + By + c \qquad Equation ( 1 )$$

$$R ( curve ) = \frac{{[ 1 + {( \frac{dx}{dy} )}^{2} ]}^{\frac{3}{2}}}{\vert \frac{{d}^{2} x}{{dy}^{2}} \vert} \qquad Equation ( 2 )$$

In other examples, the control module 104 may leverage existing classical or deep learning-based techniques to determine the estimated polynomials corresponding to the parking space lines (e.g., the parking space lines 404, 406) in the captured image(s). For instance, the control module 104 may implement PolyLaneNet or another suitable machine learning (ML) technique that implements lane detection on received image(s) and outputs polynomials representing each lane marking in the image(s) via, for example, deep polynomial regression.

In various embodiments, the control module 104 may then generate a virtual parking space line corresponding to at least one parking space line based on the estimated polynomial. For instance, and with continued reference to FIG. 4, the parking space line 404 is difficult to view due to, for example, degradation, obscurations, glare, etc. In this example, the control module 104 may then generate a virtual parking space line corresponding to the entire the parking space line 404 or one or more missing portions of the parking space line 404 based on the estimated polynomial for the line 404.

The virtual parking space line may extend along its corresponding parking space line as desired. For example, the generated virtual parking space line for the parking space line 404 may extend to a horizon line associated with the parking space 402. In other words, in the example of FIG. 4, the generated virtual parking space line may extend to the parking stone 408 (or the line 410). In other examples, the generated virtual parking space line may extend short of the horizon line (e.g., the parking stone 408) or to another suitable location.

In various embodiments, the control module 104 may generate and rely on additional polynomials for use in generating virtual lines. For example, the control module 104 may leverage the orientation of other vehicles parked nearby to enhance the parking space lines estimate. For instance, the control module 104 may detect a feature of a vehicle adjacent to the parking space 402, such as one or both parked vehicles 416, 418 of FIG. 4. As one example, the control module 104 may detect a lower edge of the vehicle 416 between tires 420, 422 and then interpolate a line 424 between the tires 420, 422. Additionally, if desired, the control module 104 may detect a lower edge of the vehicle 418 between tires 426, 428 and then interpolate another line 430 between the tires 426, 428. Then, the control module 104 may generated estimated polynomials representing the detected features (e.g., the lower edges of the vehicles 416, 418). In examples of where multiple vehicles (e.g., the vehicles 416, 418) are present in the same parking segment, the control module 104 may average the estimates to increase robustness. Existing edge detection techniques (e.g., the Canny edge detector approach, etc.), tire detection models, trained ML models, etc. can be leveraged for such actions.

Additionally, the control module 104 may leverage externally received data to enhance the parking space lines estimate. For example, the control module 104 may rely on map information (e.g., satellite data, etc.) which may or may not originate based on crowd-sourced data. For instance, the control module 104 may receive map data for an area adjacent to or encompassing the parking space 402. In such examples, the control module 104 may use map matching to determine vehicle pose in a map relative to nearby lane lines. Then, the control module 104 may generated estimated polynomials representing the parking space lines 404, 406 and/or other parking space lines in the parking lot based on the map data.

For example, with respect to satellite-based data, the control module 104 may determine a vehicle's orientation in a parking lot by applying a car detection model that provides a bounding box around the vehicle. Then, the control module 104 may estimate polynomials based on points along the longer end (e.g., a vertical line) of the bounding boxes, as most vehicles are long on the sides and short from back. The location and orientation of a parking space line features/polynomials can then be determined by the control module 104 relative to a reference point. For instance, for a GPS coordinate frame, the control module 104 may rely on a latitude, a longitude, and a heading with respect to north as a reference point.

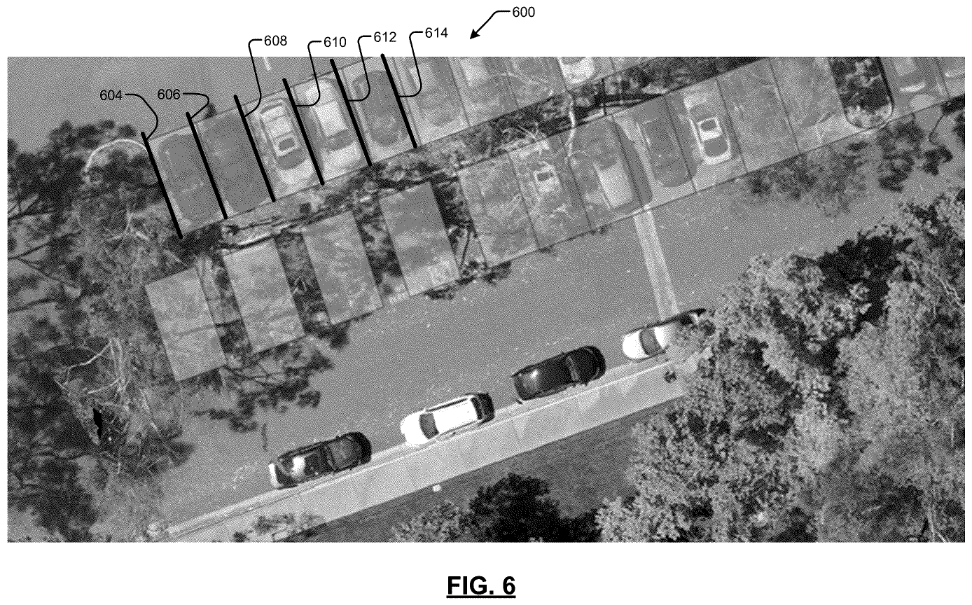

FIGS. 5-6 depict examples images 500, 600 containing map information received by the control module 104. For example, in FIG. 5, the control module 104 may receive map data (e.g., coordinates) for parking space lines 504, 506 and/or other lines, and then generated estimated polynomials representing the lines 504, 506 and/or other lines. In FIG. 6, the image 600 show bounding boxes around vehicles in a parking lot, which can be relied on by the control module 104 to generate estimated polynomials representing parking space lines 604, 606, 608, 610, 612, 614 and/or other lines.

Then, once the additional estimated polynomials are generated for detected features of neighboring vehicles and/or based on map data, the control module 104 may rely on one or more of these estimated polynomials to generate the virtual parking space line. For instance, the control module 104 may generate the virtual parking space line corresponding to the entire the parking space line 404 or one or more missing portions of the parking space line 404 based on the estimated polynomial for the line 404, the estimated polynomial for the line 424 and/or the line 430 (or the lower edges of the vehicles 416, 418), and/or the estimated polynomials based on the map data. In such examples, the estimated polynomials may be combined to generate a new estimated polynomial for a particular parking space line (e.g., the parking space line 404) or the estimated polynomial for the line 404 may be adjusted as necessary based on the other estimated polynomials for the detected vehicle feature(s) and/or based on the map data. For example, Equations (3), (4), (5) below represent example functions for the initial estimated polynomial, a detected vehicle feature, and map data, respectively. Then, Equation (6) below represents one example function with the estimated polynomials of Equations (3), (4), (5) combined. While Equation (6) provide one example of combining the estimated polynomials, it should be appreciated that other suitable functions may be implemented for combining the estimated polynomials if desired.

$${f}_{i} ( y ) = {Ay}^{2} + By + c \qquad Equation ( 3 )$$

$${f}_{c} ( y ) = {Ey}^{2} + Fy + g \qquad Equation ( 4 )$$

$${f}_{m} ( y ) = {Py}^{2} + Qy + r \qquad Equation ( 5 )$$

$${f}_{n} ( y ) = {f}_{i} ( y ) + {f}_{c} ( y ) + {f}_{m} ( y ) \qquad Equation ( 6 )$$

In various embodiments, the control module 104 may apply a weight to any one or all of the estimated polynomials. In such examples, each weight may be a calibrated (e.g., defined) value, determined based on ML techniques, etc. Additionally, the weights may change or otherwise be adjusted based on location of the vehicle 102 (e.g., in Florida vs in Michigan, the time of year (e.g., winter season vs summer season), the time of day, the weather, etc. For example, Equation (7) below shows three weight values for the estimated polynomials of Equations (3), (4), (5) above, and Equation (8) below represents an example function with the weighted estimated polynomials of Equations (3), (4), (5) combined.

$$1 = {λ}_{i} + {λ}_{c} + {λ}_{m} \qquad Equation ( 7 )$$

$${f}_{n} ( y ) = {λ}_{i} * {f}_{i} ( y ) + {λ}_{c} * {f}_{c} ( y ) + {λ}_{m} * {f}_{m} ( y ) \qquad Equation ( 8 )$$

In various embodiments, the control module 104 may transform data from one coordinate frame or system to another coordinate frame or system. For example, features (e.g., coordinate points, lines, etc.) detected by the control module 104 from the captured image(s) may need to be transformed via one or more transforms (e.g., one or more transform matrices) into a different view of the vehicle 102 (e.g., how they would look like in the vehicle's camera view) to show the driver. This may include, for example, the detected features associated with the parking space lines 404, 406, detected features associated with the vehicles 416, 418, etc. In other examples, the control module 104 may apply one or more transforms (e.g., one or more transform matrices, such as a GPS to camera view transform) to the map data for parking space line features (e.g., in a GPS/ENU frame) to convert the data into a coordinate frame for the vehicle 102. The control module 104 may then detect the parking space line(s) and generate the estimated polynomial(s) based on the transformed data, as explained above. Equation (9) below provides one example of a GPS to camera view transform, and Equation (10) below provides one example of transforming a lane line feature in a GPS/ENU frame to the vehicle's camera view.

$${}^{l , view} {T}_{l , GPS} \qquad Equation ( 9 )$$

$${}^{l , view} {T}_{l , map} = {}^{l , view} {T}_{l , vehicle} * {}^{l , vehicle} {T}_{l , map} \qquad Equation ( 10 )$$

With continued reference to FIG. 1, the display module 114 render a view with the virtual parking space line generated by the control module 104. In such examples, the virtual parking space line may be superimposed over the entire parking space line (e.g., the parking space lines 404, etc.) or a portion (e.g., only the missing portions) of the parking space line. For instance, the control module 104 may generate a signal or data representing the virtual parking space line, and then transmits the signal or data to the display module 114, which in turn may render the view withe the virtual parking space line in real time for the driver.

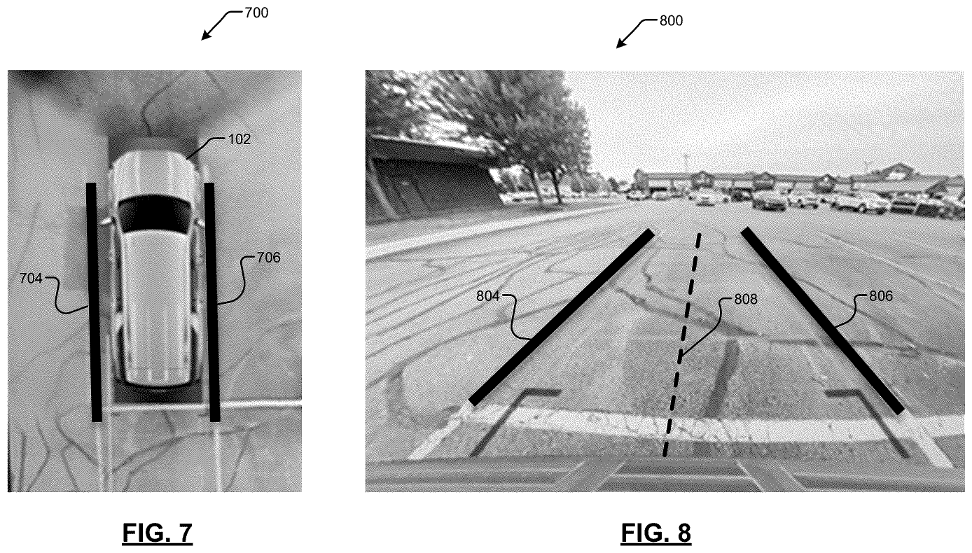

For example, FIGS. 7-8 depict example displays 700, 800 of different views provided by the display module 114 of FIG. 1. As shown in FIG. 7, the display 700 provides a bird's eye view of the vehicle 102 with two virtual parking space line 704, 706. In FIG. 8, the display 800 provides a front (or a rear) view of the vehicle 102 with two virtual parking space line 804, 706.

In various embodiments, the driver of the vehicle 102 may be notified in real time as to whether the vehicle 102 needs to shift to ensure the vehicle 102 is centered in a parking spot. For example, one or both of the virtual parking space lines 704, 706, 804, 806 of FIGS. 7-8 may change color in real time to provide direction to the driver to manipulate the vehicle 102 into a center position of the parking spot. In such examples, the virtual parking space line may become green to notify the driver to steer towards that virtual line, red to notify the driver to steer away from that virtual line, etc.

Additionally, in some embodiments, the display module 114 may add a center guideline to assist the driver to center the vehicle 102 properly between the created virtual parking space lines. For example, in FIG. 8, the display 800 provides a center guideline 808.

In various embodiments, the control module 104 of FIG. 1 detect parking space lines and/or generate virtual parking space lines based on color. For example, parking space lines are generally yellow or white in color. In other scenarios, parking space lines may be another color, such as green or blue to indicate specially designated areas. In such examples, the control module 104 may detect a color associated with at least a portion of the parking space line (e.g., the parking space line 404 of FIG. 4) based on image processing techniques, and then generate a virtual parking space line with that same detected color.

In other embodiments, the control module 104 may filter out some of the detected parking space lines based on color. For instance, after detecting multiple lines including the parking space lines (e.g., the parking space lines 404, 406 of FIG. 4), the control module 104 may apply a filter based on a defined set of colors. For instance, the control module 104 may remove lines that are not yellow, white, green, blue, or another commonly used color for parking space lines. This may reduce the set of parking space lines for identification by the control module 104.

Additionally, in some examples, the generate a virtual parking space line with a selected color. For example, the control module 104 may detect multiple shades of color and/or multiple colors associated with a detected parking space line based on image processing techniques. Then, the control module 104 may detect select one of the detected shades/colors based on a number of occurrences of each detected shade/color. For example, the control module 104 may implement an “up vote” scheme to count the occurrences of each detected shade/color, and then select the shade/color with the highest occurrences. Then, the control module 104 may detect generate the virtual parking space line with the selected color.

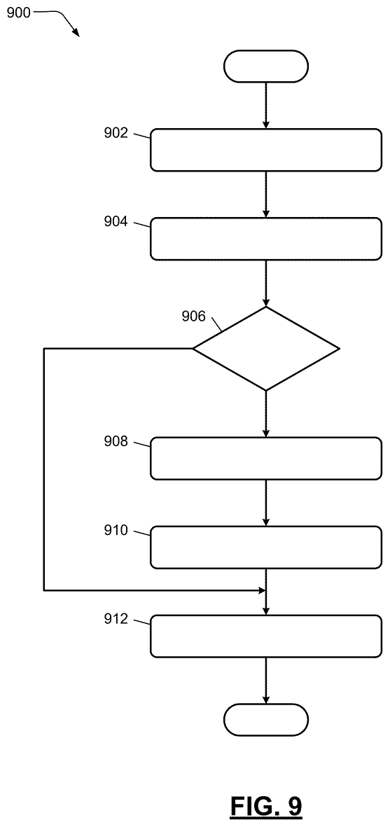

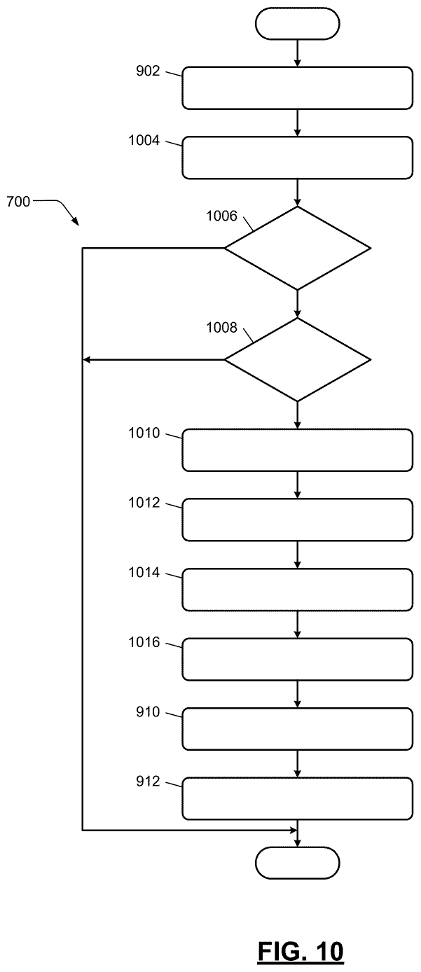

FIGS. 9-10 illustrate example methods 900, 1000 employable by the vehicle system 100 of FIG. 1 for enhancing display of a parking space line adjacent to the vehicle 102. Although the example methods 900, 1000 are described in relation to the vehicle system 100 of FIG. 1 including the control module 104, the display module 114, etc., any one of the methods 900, 1000 may be employable by another suitable system and/or module.

As shown in FIG. 9, the method 900 begins at 902 by the control module 104 receiving camera image(s) captured by, for example, the cameras 106, 108, 110, 112. The method 900 then proceeds to 904, where the control module 104 detects a parking space line or a portion thereof. For example, and as explained above, the control module 104 may implement an edge detection algorithm or another suitable approach to detect the parking space line. The method 900 then proceeds to 906.

At 906, the control module 104 determines whether a portion of the parking space line is missing or otherwise of low viewing quality. This may be accomplished through image processing techniques. If yes, the method 900 proceeds to 908. Otherwise, if no at 906, the method 900 proceeds to 912.

At 908, the control module 104 generates an estimated polynomial representing the parking space line. For example, and as explained above, the control module 104 may generate the estimated polynomial with conventional line equations (e.g., Equation (1) above), with classical or deep learning-based techniques, etc. The method 900 then proceeds to 910, where the control module 104 generates a virtual parking space line based on the estimated polynomial. In such examples, the virtual parking space line may correspond to missing portion(s) of or the entire parking space line, as explained above. Then, the method 900 proceeds to 912, where the display module 114 renders a view with the virtual parking space line in real time for the driver. The method 900 may then end as shown in FIG. 9.

The method 1000 of FIG. 10 is similar to the method 900 of FIG. 9 but includes additional and/or alternative steps. For example, as shown in FIG. 10, the method 1000 beings at 902 of FIG. 9 explained above and then proceeds to 1004, 1006. At 1004, the control module 104 receives sensor data. Then, at 1006, the control module 104 determines whether the vehicle 102 is located in a parking lot. In various embodiments, the control module 104 make this determination based on GPS data or the like received at 1004. If no at 1006, the method 1000 may end as shown in FIG. 10. If yes at 1006, the method 1000 proceeds to 1008. At 1008, the control module 104 determines whether the vehicle speed is less than or equal to a defined threshold, such as 4 km/hr, 5 km/hr, 6 km/hr, etc. If no, the method 1000 may end as shown in FIG. 10. If yes at 1006, the method 1000 proceeds to 1010.

At 1010, the control module 104 performs edge detection analysis on the captured image(s) from 902. Then, the method 1000 proceeds to 1012, where the control module 104 applies one or more transforms to convert data and identify lines in the image(s). In such examples, the control module 104 may implement a Hough Transform or another suitable transform as explained above. The method 1000 then proceeds to 1014.

At 1014, the control module 104 may apply a filter to identify desired parking space lines. For example, the control module 104 may filter to remove non-vertical lines and maintain vertical lines, as explained above. Additionally, in some examples, the control module 104 may filter the lines based on color, as explained above. The method 1000 then proceeds to 1016.

At 1016, the control module 104 generates one or more estimated polynomials. For example, and as explained above, the control module 104 may generate an estimated polynomial representing each identified or otherwise detected parking space line, an estimated polynomial representing detected features of adjacent vehicles, an estimated polynomial representing based on received map information, etc. The method 1000 then proceeds to 910, 912 of FIG. 9, where the control module 104 generates one or more virtual parking space lines based on the estimated polynomial(s), and the display module 114 renders a view with the virtual parking space line(s) in real time for the driver. The method 1000 may then end as shown in FIG. 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for enhancing display of at least one parking space line adjacent to a vehicle, the vehicle system comprising:
one or more cameras configured to capture one or more images external to the vehicle;
a control module in communication with the one or more cameras, the control module configured to:
detect a portion of a parking space line defining at least a portion of a parking space based on the one or more captured images;
generate an estimated polynomial representing the parking space line based on the detected portion of the parking space line; and
generate a virtual parking space line corresponding to at least one missing portion of the parking space line based on the estimated polynomial; and
a display module in communication with the control module, the display module configured to render a view with the virtual parking space line superimposed over the parking space line.

2. The vehicle system of claim 1, wherein the parking space line is a line extending substantially parallel to the vehicle when the vehicle is located in the parking space.

3. The vehicle system of claim 2, wherein the control module is configured to generate the virtual parking space line extending to a horizon line associated with the parking space.

4. The vehicle system of claim 2, wherein:
the estimated polynomial is a first estimated polynomial; and
the control module is configured to detect a feature of a vehicle adjacent to the parking space, generate a second estimated polynomial representing the feature of the adjacent vehicle, and generate the virtual parking space line based on the first estimated polynomial and the second estimated polynomial.

5. The vehicle system of claim 4, wherein the control module is configured to:
apply a weight to each of the first estimated polynomial and the second estimated polynomial; and
generate the virtual parking space line based on the weighted first estimated polynomial, and the weighted second estimated polynomial.

6. The vehicle system of claim 2, wherein:
the estimated polynomial is a first estimated polynomial; and
the control module is configured to receive map data for an area adjacent to or encompassing the parking space, generate a second estimated polynomial representing the parking space line based on the map data, and generate the virtual parking space line based on the first estimated polynomial and the second estimated polynomial.

7. The vehicle system of claim 6, wherein the control module is configured to:
apply a weight to each of the first estimated polynomial and the second estimated polynomial; and
generate the virtual parking space line based on the weighted first estimated polynomial and the weighted second estimated polynomial.

8. The vehicle system of claim 1, wherein the control module is configured to:
receive data representing the one or more captured images in a first coordinate system;
apply a transform to the data to convert the data into a second coordinate system; and
detect the portion of the parking space line and generate the estimated polynomial based on the transformed data.

9. The vehicle system of claim 1, wherein the control module is configured to:
detect a plurality of lines of including the portion of the parking space line; and
apply a filter to the plurality of lines based on a defined set of colors to identify the portion of the parking space line.

10. The vehicle system of claim 1, wherein the control module is configured to:
detect a plurality of colors associated with the portion of the parking space line;
select one of the detected colors based on a number of occurrences of each detected color; and
generate the virtual parking space line with the selected color.

11. The vehicle system of claim 1, wherein the control module is configured to:
detect a color associated with the portion of the parking space line; and
generate the virtual parking space line with the detected color.

12. A vehicle system for enhancing display of at least one parking space line adjacent to a vehicle, the vehicle system comprising:
one or more cameras configured to capture one or more images external to the vehicle;
a control module in communication with the one or more cameras, the control module configured to:
detect a portion of a parking space line defining at least a portion of a parking space based on the one or more captured images and generate a first estimated polynomial representing the parking space line based on the detected portion of the parking space line;
detect a feature of a vehicle adjacent to the parking space based on the one or more captured images and generate a second estimated polynomial representing the feature of the adjacent vehicle;
receive map data for an area adjacent to or encompassing the parking space and generate a third estimated polynomial representing the parking space line based on the map data; and
generate a virtual parking space line corresponding to at least one missing portion of the parking space line based on the first estimated polynomial, the second estimated polynomial, and the estimated polynomial; and
a display module in communication with the control module, the display module configured to render a view with the virtual parking space line superimposed over the parking space line.

13. The vehicle system of claim 12, wherein the control module is configured to:
apply a weight to each of the first estimated polynomial, the second estimated polynomial, and the third estimated polynomial; and
generate the virtual parking space line based on the weighted first estimated polynomial, the weighted second estimated polynomial, and the weighted third estimated polynomial.

14. The vehicle system of claim 13, wherein the control module is configured to:
detect a color associated with the portion of the parking space line; and
generate the virtual parking space line with the detected color.

15. A method for enhancing display of at least one parking space line adjacent to a vehicle, the method comprising:
capturing one or more images external to the vehicle;
detecting a portion of a parking space line defining at least a portion of a parking space based on the one or more captured images;
generating an estimated polynomial representing the parking space line based on the detected portion of the parking space line;
generating a virtual parking space line corresponding to at least one missing portion of the parking space line based on the estimated polynomial; and
rendering, on a display module, a view with the virtual parking space line superimposed over the parking space line.

16. The method of claim 15, wherein:
the parking space line is a line extending substantially parallel to the vehicle when the vehicle is located in the parking space; and
generating the virtual parking space line includes generating the virtual parking space line extending to a horizon line associated with the parking space.

17. The method of claim 15, wherein:
the estimated polynomial is a first estimated polynomial; and
the method further includes detecting a feature of a vehicle adjacent to the parking space, and generating a second estimated polynomial representing the feature of the adjacent vehicle; and
generating the virtual parking space line includes generating the virtual parking space line based on the first estimated polynomial and the second estimated polynomial.

18. The method of claim 17, wherein:
the method further includes receiving map data for an area adjacent to or encompassing the parking space and generating a third estimated polynomial representing the parking space line based on the map data; and
generating the virtual parking space line includes generating the virtual parking space line based on the first estimated polynomial, the second estimated polynomial, and the third estimated polynomial.

19. The method of claim 18, wherein:
the method further includes applying a weight to each of the first estimated polynomial, the second estimated polynomial, and the third estimated polynomial; and
generating the virtual parking space line includes generating the virtual parking space line based on the weighted first estimated polynomial, the weighted second estimated polynomial, and the weighted third estimated polynomial.

20. The method of claim 15, wherein:
the method further includes detecting a plurality of colors associated with the portion of the parking space line and selecting one of the detected colors based on a number of occurrences of each detected color; and
generating the virtual parking space line includes generating the virtual parking space line with the selected color.
